(19) United States
(12) Patent Application Publication
(10) Pub. No.: US 2012/0157019 A1
(43) Pub. Date: Jun. 21, 2012

(54) WIRELESS POWER TRANSMISSION SYSTEM, WIRELESS POWER TRANSMITTING APPARATUS AND WIRELESS POWER RECEIVING APPARATUS

(76) Inventor: Pai-Chi LI, Taipei (TW)

(21) Appl. No.: 13/071,813

(22) Filed: Mar. 25, 2011

(30) Foreign Application Priority Data
Dec. 16, 2010 (TW) 099144241

(51) Int. Cl. H04W 52/04; H02J 4/00

(52) U.S. Cl. 455/127.1; 307/149

(57) ABSTRACT

A wireless power transmission system includes a wireless power transmitting apparatus and a wireless power receiving apparatus. The wireless power transmitting apparatus includes a signal generator and an ultrasonic transmitting unit. The ultrasonic transmitting unit generates and outputs a focused ultrasonic wave according to a signal outputted from the signal generator. The wireless power receiving apparatus includes an ultrasonic receiving unit and a power conversion unit. The ultrasonic receiving unit receives the focused ultrasonic wave outputted from the wireless power transmitting apparatus and converts the focused ultrasonic wave into electrical power energy. The power conversion unit performs a power conversion on the electrical power energy and thereby provides the converted electrical power energy to a back-end circuit. The ultrasonic signal can also be encoded in the transmitting unit and subsequently decoded in the receiving unit as a means to remotely control the back-end circuit in the receiving unit.

### FIELD OF THE INVENTION

The present invention relates to a wireless power transmission technology, and more particularly to a wireless power transmission system utilizing a focused ultrasonic wave for the transmission of wireless power, and a wireless power transmitting apparatus and a wireless power receiving apparatus of such wireless power transmission system.

### BACKGROUND OF THE INVENTION

So far, the technologies of transmitting wireless power via radio frequency (RF) signal have been developed. For example, the U.S. Pat. No. 7,068,991 has disclosed a related technology about the wireless power transmission via the RF signal and its applications.

However, the applications of the RF signal in the area of biomedical applications (such as implantable medical devices) still have some limitations needed to be overcome. These limitations are mainly resulted by three reasons. In particular, a first one of the reasons is that electromagnetic waves generated from the RF signal may be harmful to biology, a second one of the reasons is that the RF signal located within a general frequency range (for example, 3 KHz˜300 MHz) cannot be efficiently focused at a relatively short distance (for example, within 1 m), and a third one of the reasons is that the RF signal located within the ultra high frequency range (for example, higher than 300 MHz) is easily to be absorbed by materials, so as not easily to be transmitted.

### SUMMARY OF THE INVENTION

Therefore, the present invention is directed to provide a wireless power transmitting apparatus capable of transmitting wireless power via a focused ultrasonic wave and thereby being suitable for the biomedical applications.

The present invention further is directed to provide a wireless power receiving apparatus suitable for use together with the wireless power transmitting apparatus.

The present invention still further is directed to provide a wireless power transmission system including the wireless power transmitting apparatus and the wireless power receiving apparatus.

More specifically, a wireless power transmitting apparatus in accordance with an embodiment of the present invention is adapted for use together with a wireless power receiving apparatus. The wireless power transmitting apparatus comprises a signal generator and an ultrasonic transmitting unit. The ultrasonic transmitting unit is configured (i.e., structured and arranged) to generate and output a focused ultrasonic wave according to a signal outputted from the signal generator, so that the wireless power receiving apparatus can receive the focused ultrasonic wave and convert the focused ultrasonic wave into electrical power energy.

In one embodiment, the above mentioned ultrasonic transmitting unit comprises at least one ultrasonic transmitting probe.

In one embodiment, the above mentioned ultrasonic transmitting unit is equipped with a single ultrasonic transmitting probe, so that an output sound field thereof is facilitated to be controlled in a fixed focusing manner.

In one embodiment, the above mentioned ultrasonic transmitting unit is equipped with a plurality of ultrasonic transmitting probes so that an output sound field thereof is facilitated to be controlled in a dynamic focusing manner.

In one embodiment, the above mentioned ultrasonic transmitting unit further comprises a lens. The lens is configured to convert an ultrasonic wave which is outputted from the ultrasonic transmitting probe into the focused ultrasonic wave.

In one embodiment, the above mentioned wireless power transmitting apparatus further comprises a power amplifier. The power amplifier is coupled between the signal generator and the ultrasonic transmitting unit and is configured to amplify the signal generated from the signal generator.

In one embodiment, the above mentioned wireless power transmitting apparatus further comprises an encoder. The encoder is configured to output an encoded data to the signal generator, so that the signal generator generates an encoded signal according to the encoded data.

In one embodiment, the above mentioned wireless power transmitting apparatus further comprises a control unit. The control unit is configured to control the encoder to generate the encoded data.

Moreover, a wireless power receiving apparatus in accordance with another embodiment of the present invention comprises an ultrasonic receiving unit and a power conversion unit. The ultrasonic receiving unit is configured to receive a focused ultrasonic wave which is outputted from a wireless power transmitting apparatus and convert the focused ultrasonic wave into electrical power energy. The power conversion unit is configured to perform a power conversion on the electrical power energy which is outputted from the ultrasonic receiving unit and supply the converted electrical power energy to a back-end circuit for use.

In one embodiment, the above mentioned ultrasonic receiving unit comprises at least one ultrasonic receiving probe.

In one embodiment, the above mentioned ultrasonic receiving unit is equipped with a single ultrasonic receiving probe, so that the receiving of a sound field is facilitated to be controlled in a fixed focusing manner.

In one embodiment, the above mentioned ultrasonic receiving unit is equipped with a plurality of ultrasonic receiving probes, so that the receiving of a sound field is facilitated to be controlled in a dynamic focusing manner.

In one embodiment, the above mentioned wireless power receiving apparatus further comprises a decoder. The decoder is configured to obtain a decoded data through decoding the signal outputted from the power conversion unit and provide the decoded data to the back-end circuit, so that the back-end circuit performs a corresponding operation based on the decoded data.

In one embodiment, the above mentioned wireless power receiving apparatus further comprises an energy storage unit. The energy storage unit is configured to store the electrical power energy outputted from the power conversion unit and further supply the stored electrical power energy to the back-end circuit.

In addition, a wireless power transmission system in accordance with still another embodiment of the present invention comprises a wireless power transmitting apparatus and a wireless power receiving apparatus. The wireless power transmitting apparatus comprises a signal generator and an ultrasonic transmitting unit. The ultrasonic transmitting unit is configured to generate and output a focused ultrasonic wave according to a signal outputted from the signal generator. The wireless power receiving apparatus comprises an ultrasonic receiving unit and a power conversion unit. The ultrasonic receiving unit is configured to receive the focused ultrasonic wave and convert the focused ultrasonic wave into electrical power energy. The power conversion unit is configured to perform a power conversion on the electrical power energy which is outputted from the ultrasonic receiving unit and supply the converted electrical power energy to a back-end circuit for use.

In summary, the present invention uses the focused ultrasonic wave to achieve wireless power transmission. Because the focused ultrasonic wave has an advantage of definite energy transmission path in a specific space, the ultrasonic power can be focused to the receiving apparatus, and therefore the efficiency of wireless power transmission is improved. Moreover, because the ultrasonic wave does not generate ionizing radiation, and thus is suitable for the biomedical applications (such as applied into implantable medical devices). In addition, the focused ultrasonic wave can be used for data transmission and thereby achieving various applications.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic block diagram of a wireless power transmission system in accordance with an embodiment of the present invention; and

FIG. 2 is a schematic cross-sectional side view of an ultrasonic transmitting probe in accordance with an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

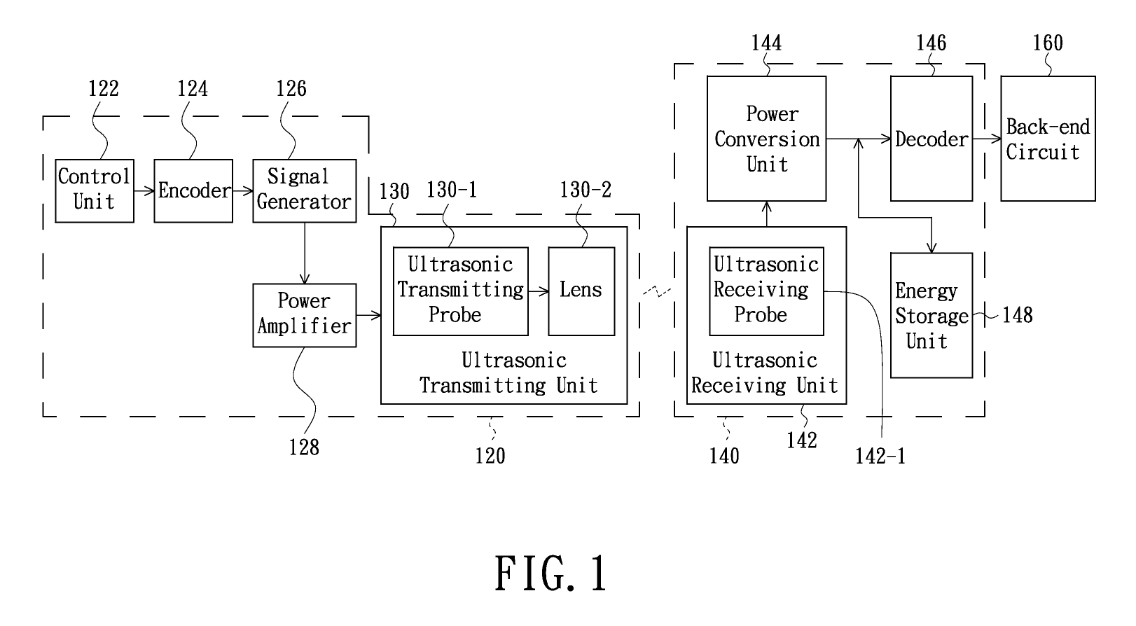

FIG. 1 is a schematic block diagram of a wireless power transmission system in accordance with an embodiment of the present invention. As depicted in FIG. 1, the wireless power transmission system comprises a wireless power transmitting apparatus 120 and a wireless power receiving apparatus 140. The wireless power transmission system is configured (i.e., structured and arranged) for supplying electrical power energy (i.e., operating power supply) to a back-end circuit 160 for use. The wireless power receiving apparatus 140 and the back-end circuit 160 can be integrated to be a single device, such as an implantable medical device. Implementations of the wireless power transmitting apparatus 120 and the wireless power receiving apparatus 140 will be described below in detail.

In particular, the wireless power transmitting apparatus 120 mainly comprises a signal generator 126 and an ultrasonic transmitting unit 130. The ultrasonic transmitting unit 130 is configured to generate and output a focused ultrasonic wave according to the signal outputted from the signal generator 126. The ultrasonic transmitting unit 130 comprises at least one ultrasonic transmitting probe 103-1. When the ultrasonic transmitting unit 130 is equipped with a single ultrasonic transmitting probe, a fixed focusing manner may be adopted for the controlling of output sound field (i.e., generally transmitting sound field). Alternatively, when the ultrasonic transmitting unit 130 is equipped with multiple ultrasonic transmitting probes, a dynamic focusing manner may be adopted for the controlling of output sound field. In addition, in the situation of the ultrasonic transmitting unit 130 being equipped with multiple ultrasonic transmitting probes, these multiple ultrasonic transmitting probes can be arranged in a form of one-dimensional array or in a form of two-dimensional array.

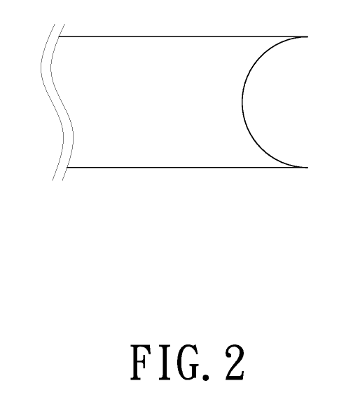

FIG. 2 is a schematic cross-sectional side view of the ultrasonic transmitting probe adopted in a preferred embodiment of the present invention. Instead of having a flat surface structure at the output end in the prior-art, the ultrasonic transmitting probe adopted in the preferred embodiment of the present invention has a concave surface structure (i.e., generally arc-shaped depression) at its output end for readily producing a focused ultrasonic wave, as depicted in FIG. 2. Please refer back to FIG. 1, if the ultrasonic transmitting unit 130 is equipped with a conventional ultrasonic transmitting probe 130-1 with a flat surface structure at its output end, an extra lens 130-2 is necessary to be arranged in the ultrasonic transmitting unit 130 for converting the ultrasonic wave outputted from the ultrasonic transmitting probe 130-1 into the focused ultrasonic wave.

In a preferred embodiment, the wireless power transmitting apparatus 120 further comprises a power amplifier 128. The power amplifier 128 is coupled between the signal generator 126 and the ultrasonic transmitting unit 130 and configured to amplify the signal outputted from the signal generator 126. Moreover, when data or information is needed to be transmitted via the focused ultrasonic wave, the wireless power transmitting apparatus 120 may further comprise an encoder 124. The encoder 124 is configured to output encoded data to the signal generator 126, and an encoded signal is accordingly generated and outputted from the signal generator 126 based on the encoded data. Even, the wireless power transmitting apparatus 120 may further comprise a control unit 122. The control unit 122 is configured to control the encoder 124 to generate the encoded data.

As depicted in FIG. 1, the wireless power receiving apparatus 140 mainly comprises an ultrasonic receiving unit 142 and a power conversion unit 144. The ultrasonic receiving unit 142 is configured to receive the focused ultrasonic wave outputted from the wireless power transmitting apparatus 120 and convert the received focused ultrasonic wave into electrical power energy. The power conversion unit 144 is configured to perform a power conversion on the electrical power energy outputted from the ultrasonic receiving unit 142 and further supply the converted electrical power energy to the back-end circuit 160 for use. The ultrasonic receiving unit 142 comprises at least one ultrasonic receiving probe 142-1. When the ultrasonic receiving unit 142 is equipped with a single ultrasonic receiving probe, a fixed focusing manner may be adopted for controlling the receiving of a sound field. Alternatively, when the ultrasonic receiving unit 142 is equipped with multiple ultrasonic receiving probes, a dynamic focusing manner may be adopted for controlling the receiving of the sound field. In addition, in the situation of the ultrasonic receiving unit 142 being equipped with multiple ultrasonic receiving probes, these multiple ultrasonic receiving probes can be arranged in a form of one-dimensional array or in a form of two-dimensional array instead.

In a preferred embodiment, when the wireless power transmitting apparatus 120 is equipped with the encoder 124 so that the focused ultrasonic wave outputted from the wireless power transmitting apparatus 120 is carried with the encoded data produced from the encoder 124, the wireless power receiving apparatus 140 may further comprise a decoder 146 for performing a decoding operation. In other words, decoded data can be obtained via the decoder 146 performing the decoding operation on a signal outputted from the power conversion unit 144. Afterwards, the decoder 146 can provide the decoded data to the back-end circuit 160, so that the back-end circuit 160 accordingly performs corresponding operations based on the decoded data. Moreover, the wireless power receiving apparatus 140 may further comprise an energy storage unit 148. The energy storage unit 148 is configured to store the electrical power energy outputted from the power conversion unit 144, and further supply the stored electrical power energy to the back-end circuit 160 for use.

To sum up, the present invention uses the focused ultrasonic wave to achieve wireless power transmission. Since the focused ultrasonic wave has an advantage of definite energy transmission path in a specific space, the ultrasonic energy can be focused to the receiving apparatus, and thereby the efficiency of wireless power transmission is improved consequently. Moreover, since the ultrasonic wave does not generate radiation and thus is suitable for the biomedical applications (such as applied to implantable medical devices). In addition, the focused ultrasonic wave also can be applied to carry out data transmission and thereby achieving various applications.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A wireless power transmitting apparatus adapted for use together with a wireless power receiving apparatus and comprising:
a signal generator; and
an ultrasonic transmitting unit, for generating and transmitting a focused ultrasonic wave according to a signal outputted from the signal generator and thereby facilitating the wireless power receiving apparatus to receive the focused ultrasonic wave and convert the focused ultrasonic wave into electrical power energy.

2. The wireless power transmitting apparatus according to claim 1, wherein the ultrasonic transmitting unit comprises at least one ultrasonic transmitting probe.

3. The wireless power transmitting apparatus according to claim 2, wherein the ultrasonic transmitting unit is equipped with one ultrasonic transmitting probe and thereby an output sound field thereof is controlled in a fixed focusing manner.

4. The wireless power transmitting apparatus according to claim 2, wherein the ultrasonic transmitting unit is equipped with a plurality of ultrasonic transmitting probes and thereby an output sound field thereof is controlled in a dynamic focusing manner.

5. The wireless power transmitting apparatus according to claim 2, wherein the ultrasonic transmitting unit further comprises:
a lens, for converting an ultrasonic wave outputted from the ultrasonic transmitting probe into the focused ultrasonic wave.

6. The wireless power transmitting apparatus according to claim 1, further comprising:
a power amplifier, coupled between the signal generator and the ultrasonic transmitting unit and for amplifying the signal outputted from the signal generator.

7. The wireless power transmitting apparatus according to claim 1, further comprising:
an encoder, for transmitting an encoded data to the signal generator and thereby facilitating the signal generator to generate an encoded signal according to the encoded data.

8. The wireless power transmitting apparatus according to claim 7, further comprising:
a control unit, for controlling the encoder to generate the encoded data.

9. A wireless power receiving apparatus adapted for use together with a wireless power transmitting apparatus and comprising:
an ultrasonic receiving unit, for receiving a focused ultrasonic wave outputted from the wireless power transmitting apparatus and converting the focused ultrasonic wave into electrical power energy; and
a power conversion unit, for performing a power conversion on the electrical power energy outputted from the ultrasonic receiving unit and supplying the converted electrical power energy to a back-end circuit for use.

10. The wireless power receiving apparatus according to claim 9, wherein the ultrasonic receiving unit comprises at least one ultrasonic receiving probe.

11. The wireless power receiving apparatus according to claim 10, wherein the ultrasonic receiving unit is equipped with one ultrasonic receiving probe and thereby the receiving of sound field is controlled in a fixed focusing manner.

12. The wireless power receiving apparatus according to claim 10, wherein the ultrasonic receiving unit is equipped with a plurality of ultrasonic receiving probes and thereby the receiving of sound field is controlled in a dynamic focusing manner.

13. The wireless power receiving apparatus according to claim 9, further comprising:
a decoder, for decoding a signal outputted from the power conversion unit to obtain a decoded data and providing the decoded data to the back-end circuit to allow the back-end circuit to perform a corresponding operation based on the decoded data.

14. The wireless power receiving apparatus according to claim 9, further comprising:
an energy storage unit, for storing the electrical power energy outputted from the power conversion unit and further supplying the stored electrical power energy to the back-end circuit.

15. A wireless power transmission system comprising:
a wireless power transmitting apparatus, comprising:
a signal generator; and
an ultrasonic transmitting unit, for generating and transmitting a focused ultrasonic wave according to a signal outputted from the signal generator; and
a wireless power receiving apparatus, comprising:
an ultrasonic receiving unit, for receiving the focused ultrasonic wave and converting the focused ultrasonic wave into electrical power energy; and
a power conversion unit, for performing a power conversion on the electrical power energy outputted from the ultrasonic receiving unit and further supplying the converted electrical power energy to a back-end circuit for use.

16. The wireless power transmission system according to claim 15, wherein the ultrasonic transmitting unit comprises an ultrasonic transmitting probe, and the ultrasonic transmitting probe has a concave surface at an output end thereof.
